(19) United States
(12) Patent Application Publication
(10) Pub. No.: US 2009/0005811 A1
(43) Pub. Date: Jan. 1, 2009

(54) Teat, Pacifier, Drinking Spout and Teething Ring and Method for the Production Thereof

(75) Inventors: Alexander DuChesne, Heeslingen (DE); Steffen Berger, Zeven (DE); Heiner Blanken, Weertzen (DE); Gunter Marr, Rosengarten (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: MAPA GmbH Gummi- und Plastikwerke, Zeven (DE)

(21) Appl. No.: 12/159,909

(22) PCT Filed: Nov. 25, 2006
(86) PCT No.: PCT/EP2006/011318

§ 371 Date: Sep. 12, 2008

(30) Foreign Application Priority Data
Jan. 7, 2006 (DE) 10 2006 000 980.0

(51) Int. Cl. A61J 17/02

(52) U.S. Cl. 606/235

(57) ABSTRACT

Teat, pacifier, drinking spout or teething ring, comprising a base body which is made from at least one polymer material, and a transparent, unlcoloured layer, applied to the base body on the outside thereof from a latex and/or a polymer solution by dipping.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The present invention is related to a teat, a pacifier, a drinking spout and a teething ring and to methods for the production thereof.

Feeding teats, shortly called “teats” in the following, are caps from a flexible material for being fixed on an opening of a drinking bottle for babies. Babies can take out liquid food from the bottle through the drinking hole of the teat.

Comforting teats, shortly called “pacifiers” in the following, are flexible rubber parts with a mouth plate.

Drinking spouts are flexible caps for drinking bottles which are used by bigger children and adults.

As teething rings, ring-shaped bodies from a more or less soft material are designated, on which babies and small children can bite during teething.

Teats, pacifiers, drinking spouts and teething rings are primarily made from natural latex and silicone rubber, but also from thermoplastic elastomers. The products up to date are without added dyes, because dyes could be released out of the product during use, with disadvantageous consequences for the baby or the small child, which would not be permitted because of the valid food regulations and product-specific requirements.

However, it would be desirable to provide teats, pacifiers, drinking spouts and teething rings in a coloured design, for instance in order to distinguish products more easily from each other or because of aesthetic reasons.

Starting from this, the present invention is based on the objective to provide a coloured teat, pacifier, drinking spout or teething ring which does not release any dyes when used by the baby or the small child. Further, the present invention is based on the objective to provide a method for the production of such a teat, a pacifier, a drinking spout or a teething ring.

### BRIEF SUMMARY OF THE INVENTION

The teat, pacifier, drinking spout or teething ring according to the present invention comprises, from the inside to the outside, a coloured base body, and a transparent outer layer surrounding the base body, made from a latex and/or a polymer solution, each one thereof without a dye.

Natural as well as synthetic latex may be employed.

In the teat, pacifier, drinking spout or teething ring according to the present invention, a coloured base body is enclosed by an outer layer of an uncoloured, more or less transparent material. This layer effectively prevents the contact of the mucous membrane of the baby or small child with the coloured base body and assures that even by the predictable mechanical stress no dye pigments can be transferred to the mucous membrane or food. As a consequence, the requirements for these consumer goods are fulfilled. However, the coloured base body is visible through the transparent outer layer, so that for the first time ever coloured teats, pacifiers, drinking spouts and teething rings are provided, i.e. such ones whose colour differs from the colour of the natural rubber latex or synthetic latex without added dye additives. In this way, the products may be provided in an intense blue, orange, green or red colour, for example.

Natural rubber latex is widely spread as a material for teats, pacifiers, drinking spouts and teething rings, and from the viewpoint of manufacture, the production of the outer layer from natural rubber latex can be easily realised. It may be expected that this finds wide acceptance from the users. The use of synthetic latex for the outer layer has the advantage that latex allergies are avoided for persons with latex allergy. A suitable synthetic latex is polyisoprene latex, for example. In fact, polyisoprene does not have the same strength as natural rubber latex. However, when using a base body of a suitable material, a sufficient strength of the overall product can be obtained. In particular, it is possible to make the base body from natural rubber latex. In doing so, the outer layer of synthetic latex prevents the user from coming into contact with latex protein from the base body.

In principle, it is possible to realise the teat, pacifier, drinking spout or teething ring as a solid body, the teat or the drinking sprout being provided with a passage channel for the liquid, which connects the drinking hole with the opening towards the drinking bottle. According to one embodiment, the coloured base body is hollow. This is particularly advantageous for the production of soft or resilient, respectively, teats, pacifiers, drinking spouts and teething rings, and makes materials savings possible.

According to one embodiment, the base body has a transparent, uncoloured inner layer, applied by dipping it into a natural and/or synthetic latex and/or a polymer solution, each one containing no dye.

Different materials can be taken into consideration for the base body, wherein particularly soft or elastic materials, respectively, can be selected for a teat or a pacifier and harder materials for a teething ring. According to one embodiment, the base body consists of a composition containing a natural latex or a synthetic latex. In this embodiment, the base body has the same properties as the outer layer, so that the softness or elasticity, respectively, of the product are not different from those ones of the conventional products, which are entirely made from natural rubber latex or synthetic latex. In addition, a base body from natural rubber latex or synthetic latex can be bound to an outer layer of the same material particularly firmly.

The colouring of the base body can be obtained in different ways. According to one embodiment, the base body is made from a composition containing a dye. Thus, the dye is mixed into the composition from which the base body is made, so that an inherently coloured base body is obtained.

Further, the present application is related to a teat, pacifier, drinking spout or eething ring, comprising a base body, which can be produced from different, even coloured polymer materials (like natural rubber, silicone rubber, thermoplastic elastomers, for example) through different methods (like dipping, injection moulding, extrusion, for instance) and a transparent, uncoloured layer, applied on the outside by dipping from a latex and/or polymer solution, and in the case of a hollow base body, if required a transparent, uncoloured layer, applied on the inside by dipping from a latex and/or a polymer solution.

In a first variant of the method according to the present invention for producing a teat, pacifier, drinking spout or teething ring of the aforementioned kind, a coloured base body is dipped into a latex and/or a polymer solution, each one containing no dye, and by doing so, a transparent, uncoloured layer is obtained on the inside and/or the outside.

According to one embodiment, a coloured base body, made by dipping it into a latex and/or a polymer solution, each one containing at least one dye, is dipped into a latex and/or a polymer solution, each one containing no dye, and by doing so, it obtains a transparent, uncoloured layer on the inside and/or the outside (two-dip-method).

According to a second variant of the method according to the present invention for producing a teat, pacifier, drinking spout or teething ring of the aforementioned kind, an uncoloured base body is first dipped into a latex and/or a polymer solution, each one containing at least one dye, and by doing so a transparent, coloured layer is obtained on the inside and/or the outside, and thereafter the now coloured base body made in this way is dipped into a latex and/or a polymer solution, each one containing no dye, and by doing so a transparent, uncoloured layer is obtained as an overdip on the inside and/or the outside.

According to a further embodiment, an uncoloured base body, made by dipping it into a latex and/or a polymer solution, each one containing no dye, is first dipped into a latex and/or a polymer solution, each one containing at least one dye, and by doing so it obtains a coloured layer on the outside and/or the inside. Thereafter, the now coloured base body made in this way is dipped into a latex and/or a polymer solution, each one containing no dye, and by doing so it obtains a transparent, uncoloured layer on the inside and/or the outside as an overdip (three-dip-method)

This treatment step is a possibility with a teat in the context of feeding in particular, because in this way no dye can be transferred into the food upon contact with foodstuff.

### BRIEF DESCRIPTION OF THE SEVERAL VIEWS OF THE DRAWINGS

The present invention will be illustrated by means of the appending drawings of realisation examples in the following. In the drawings shows:

FIG. 1 a) a teat according to the present invention, in a longitudinal section;

FIG. 1 b) a drinking spout according to the present invention;

FIG. 2 a comforting teat according to the present invention, in a longitudinal section;

FIG. 3 a teething ring according to the present invention in a cross section;

FIG. 4 the same teething ring is a perspective view, slantly from the upside.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

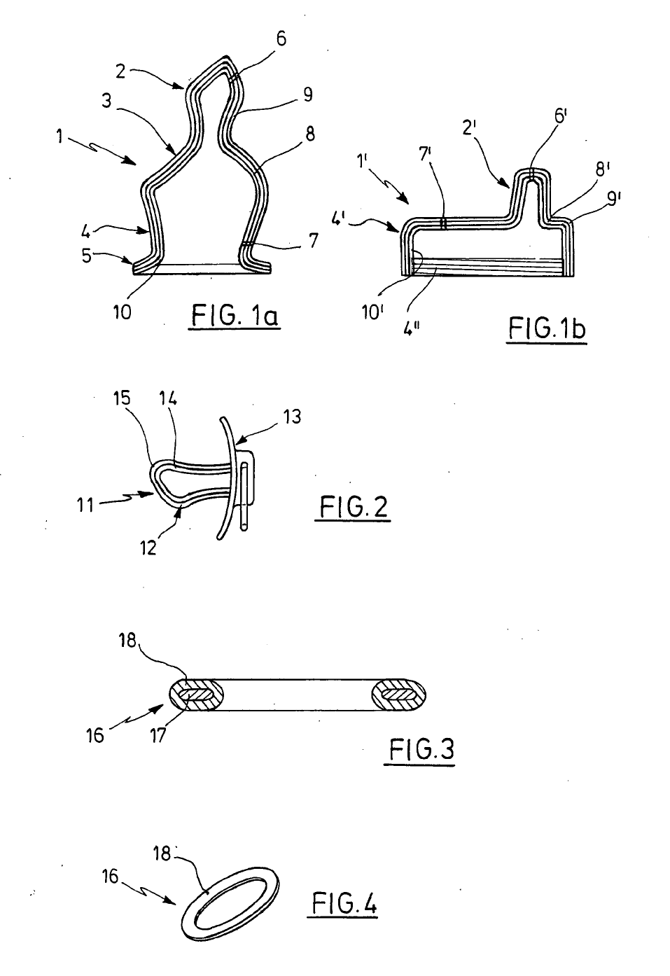

According to FIG. 1 a), a teat 1 has a nipple 2, which is connected via an enlarging transition region 3 with a sprout 4 having a flange 5 on its lower edge for fixing it on the edge of an opening of a drinking bottle. The nipple has a drinking hole 6 and an aeration hole 7.

The teat 1 has a coloured base body 8 which has a transparent outer layer 9 on its outside, made from a latex and/or a polymer solution containing no dye. Further, the teat 1 has an inner layer 10, which is also made from a latex and/or a polymer solution containing no dye.

The teat may be produced in arbitrary colours, which are easily visible from the outside through the outer layer 9 and the inner layer 10. In spite of this, no colour pigments can migrate towards the outside or reach the food, because they are securely kept back by the outer layer 9 and the inner layer 10.

In the drinking spout shown in FIG. 1 b), the features substantially functionally coincident with the features of teat 1 are designated with the same reference numerals, which are provided with a colon. Thus, the nipple 2′ seats directly on the topside of a dome-shaped sprout 4′. The nipple 2′ has the drinking hole 6′, and the sprout 4′ is provided with an aeration hole 7′ on its topside.

Further, there is a coloured base body 8′, on which a transparent outer layer 9′ is provided on the outside, and a transparent inner layer 10′ on the inside.

On the inside perimeter, the spout 4′ has a thread 4″ for screwing it on a drinking container.

Preferably, the drinking spout 1′ is substantially realised as being stiff, whereas the teat 1 is preferably realised as being soft or elastic, respectively.

According to FIG. 2, a comforting teat 11 has rubber part or pacifier 12, which is fixed on a mouth shield 13. The lubber part 12 has a coloured base part 14, which is surrounded by a transparent outer layer 15 on the outside, which is made from a latex and/or polymer solution containing a dye.

According to FIGS. 3 and 4, a teething ring 16 has a bead-shaped, coloured base body 17, which is surrounded by a transparent outer layer 18. The outer layer 18 is made from a latex and/or polymer solution containing no dye.

In the realisations of FIG. 1 to 4, the base body is made from a latex and/or a polymer solution.

The above disclosure is intended to be illustrative and not exhaustive. This description will suggest many variations and alternatives to one of ordinary sldll in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. Teat, pacifier, drinking spout or teething ring, comprising [1.1] a coloured base body (8, 14, 17), which is made from at least one polymer material, and [1.2] a transparent, uncoloured layer, applied to the base body on the outside thereof from a latex and/or a polymer solution by dipping.

2. Teat, pacifier, drinking spout or teething ring according to claim 1, wherein the coloured base body (8, 14) is hollow.

3. Teat, pacifier, drinking spout or teething ring according to claim 2, with a transparent, uncoloured inner layer (10), applied to the hollow base body on the inside thereof from a latex and/or a polymer solution by dipping.

4. Teat, pacifier, drinking spout or teething ring according to claim 1, wherein the transparent, uncoloured outer layer, applied to the coloured base body on the outside thereof, has been made by dipping from a natural and/or synthetic latex and/or a polymer solution, each one containing no dye.

5. Teat, pacifier, drinking spout or teething ring according to claim 1, wherein the transparent, uncoloured inner layer, applied to the hollow, coloured base body on the inside thereof, has been made by dipping from a natural and/or synthetic latex and/or a polymer solution, each one containing no dye.

6. Teat, pacifier, drinking spout or teething ring according to claim 1, wherein the base body (8, 14, 17) is made from natural rubber, silicon rubber or a thermoplastic elastomer.

7. Teat, pacifier, drinking spout or teething ring according to claim 1, wherein the base body consists of a material composition containing at least one dye.

8. Teat, pacifier, drinking spout or teething ring according to claim 1, wherein the base body is provided with a coloured layer on its outside and/or inside.

9. Method for producing a teat, pacifier, drinking spout or teething ring according to claim 1, wherein a coloured base body is dipped into a latex and/or a polymer solution, each one containing no dye, and by doing so a transparent, uncoloured layer is obtained on the inside and/or the outside.

10. Method according to claim 9, wherein a coloured base body, made by dipping it into a latex and/or a polymer solution, each one containing at least one dye, is dipped into a latex and/or a polymer solution, each one containing no dye, and by doing so a transparent, uncoloured layer is obtained on the inside and/or the outside (two-dip-method).

11. Method according to claim 9, wherein a coloured base body, made by dipping it at least one time into a latex and/or a polymer solution, each one containing at least one dye, is dipped at least one time into a latex and/or a polymer solution, each one containing no dye, and by doing so at least one transparent, uncoloured layer is obtained on the inside and/or the outside.

12. Method for producing a teat, pacifier, drinking spout or teething ring according to claim 8, wherein an uncoloured base body is first dipped into a latex and/or a polymer solution, each one containing at least one dye, and by doing so a coloured layer is obtained on the outside and/or the inside, and thereafter the now coloured base body made in this way is dipped into a latex and/or a polymer solution, each one containing no dye, and by doing so a transparent, uncoloured layer is obtained on the inside and/or the outside as an overdip.

13. Method according to claim 12, wherein the uncoloured base body, made by dipping it into a latex and/or a polymer solution, each one containing no dye, is first dipped into a latex and/or a polymer solution, each one containing at least one dye, and by doing so a coloured layer is obtained on the outside and/or the inside thereof, and thereafter the now coloured base body made in this way is dipped into a latex and/or a polymer solution, each one containing no dye, and by doing so a transparent, uncoloured layer is obtained on the inside and/or the outside as an overdip (three-dip-method).

14. Method according to claim 12, wherein an uncoloured base body, made by dipping it at least one time into a latex and/or a polymer solution, each one containing no dye, is first dipped at least one time into a latex and/or a polymer solution, each one containing at least one dye, and by doing so at least one coloured layer is obtained on the outside and/or the inside, and thereafter the now coloured base body made in this way is dipped at least one time into a latex and/or a polymer solution, each one containing no dye, and by doing so at least one transparent, uncoloured layer is obtained on the inside and/or the outside as an overdip.

15. Method according to claim 9, according to which the coloured base body is dipped into a natural and/or synthetic latex and/or a polymer solution, each one containing no dye, and by doing so at least one transparent, uncoloured layer is obtained on the inside and/or the outside.

16. Method according to claim 12, wherein the uncoloured base body is first dipped into a natural and/or synthetic latex and/or a polymer solution, each one containing at least one dye, and by doing so a coloured layer is obtained on the inside and/or the outside, and thereafter the now coloured base body made in this way is dipped into a natural and/or synthetic latex and/or a polymer solution, each one containing no dye, and by doing so a transparent, uncoloured layer is obtained on the inside and/or the outside as an overdip.
